(19) United States
(12) Patent Application Publication
(10) Pub. No.: US 2023/0331989 A1
(43) Pub. Date: Oct. 19, 2023

(54) PARTIAL DISPLACEMENT OF PERFORMANCE GRADED LOW CARBON ASPHALT WITH WASTE PLASTIC

(71) Applicant: Edgard Hitti, Reno, NV (US)

(72) Inventor: Edgard Hitti, Reno, NV (US)

(73) Assignee: Granite Construction Incorporated, Watsonville, CA (US)

(21) Appl. No.: 17/965,022

(22) Filed: Oct. 13, 2022

Related U.S. Application Data
(60) Provisional application No. 63/330,906, filed on Apr. 14, 2022.

(51) Int. Cl. C08L 95/00; C08J 3/21

(52) U.S. Cl. CPC C08L 95/005; C08J 3/212; C08J 2425/06; C08J 2495/00

(57) ABSTRACT

A method of forming an asphalt binder includes the steps of: providing a liquid binder base housed in a feeding tank; providing a plurality of unprocessed granules of a waste plastic material housed in a hopper; pumping the liquid binder base into a wetting tank; augering the plurality of unprocessed granules of the waste plastic material into the wetting tank; mixing the liquid binder base and the plurality of unprocessed granules of the waste plastic material to form a blended binder that includes 5 percent to 40 percent by volume of the waste plastic material and 60 percent to 95 percent by volume of the liquid binder base; pumping the blended binder into a storage tank; and mixing the blended binder at a temperature of 325° F. to 350° F. for a duration of 10 minutes to 30 minutes to form the asphalt binder.

### CROSS REFERENCE TO RELATED APPLICATION(S)

This application claims the priority benefit of U.S. Provisional Pat. Application No. 63/330,906, filed Apr. 14, 2022, which is incorporated by reference as if disclosed herein in its entirety.

### FIELD

The present technology relates generally to the field of asphalt mixes, and more particularly, to systems and methods of forming an asphalt binder that incorporates non-recyclable plastic waste without negatively impacting the performance of the resulting asphalt binder.

### BACKGROUND

Plastic waste is an environmental problem as only about 10% of plastic waste is recycled. The remaining plastic waste is generally incinerated or placed in landfills. Recent attempts have been made to reuse non-recyclable plastic waste via incorporation into new products. However, such systems and methods are limited to specific types of plastic waste and are unable to use significant amounts of plastic waste without negatively impacting the performance of the finished product.

Thus, a need exists for improved systems and methods of reusing plastic waste that addresses at least the problems described above.

### SUMMARY

According to an embodiment of the present technology, a method of forming an asphalt binder is provided. The method includes the steps of: providing a liquid binder base housed in a feeding tank; providing a plurality of unprocessed granules of a waste plastic material housed in a hopper; pumping the liquid binder base into a wetting tank; augering the plurality of unprocessed granules of the waste plastic material into the wetting tank; mixing the liquid binder base and the plurality of unprocessed granules of the waste plastic material to form a blended binder that includes 5 percent to 40 percent by volume of the waste plastic material and 60 percent to 95 percent by volume of the liquid binder base; pumping the blended binder into a storage tank; and mixing the blended binder at a temperature of 325° F. to 350° F. for a duration of 10 minutes to 30 minutes to form the asphalt binder.

In some embodiments, the blended binder includes 5 percent to 20 percent by volume of the waste plastic material and 80 percent to 95 percent by volume of the liquid binder base.

In some embodiments, the blended binder includes 10 percent by volume of the waste plastic material and 90 percent by volume of the liquid binder base.

In some embodiments, the blended binder is mixed in the storage tank at a temperature of 325° F. for a duration of 20 minutes to form the asphalt binder.

In some embodiments, the method includes the step of heating the liquid binder base within the feeding tank to a temperature of 325° F.

In some embodiments, each of the plurality of unprocessed granules of the waste plastic material is less than or equal to 1 inch in size.

In some embodiments, each of the plurality of unprocessed granules of the waste plastic material is less than or equal to ½ inch in size.

In some embodiments, the waste plastic material includes plastic material from recycling grades 3, 5, 6, and 7.

In some embodiments, the waste plastic material includes polystyrene.

In some embodiments, the liquid binder base includes up to 50 percent by volume of reclaimed asphalt pavement.

In some embodiments, the storage tank includes a high-shear mill for mixing the blended binder.

According to an alternative embodiment of the present technology, a method of forming an asphalt binder is provided. The method includes the steps of: providing a liquid binder base housed in a storage tank; providing a plurality of unprocessed granules of a waste plastic material housed in a container, each of the plurality of unprocessed granules of the waste plastic material is less than or equal to 1 inch in size; pouring the plurality of unprocessed granules of the waste plastic material into the storage tank; and mixing the liquid binder base and the plurality of unprocessed granules of the waste plastic material at a temperature of 325° F. to 350° F. for a duration of 10 minutes to 30 minutes to form the asphalt binder that includes 5 percent to 40 percent by volume of the waste plastic material and 60 percent to 95 percent by volume of the liquid binder base.

In some embodiments, the asphalt binder includes 5 percent to 20 percent by volume of the waste plastic material and 80 percent to 95 percent by volume of the liquid binder base.

In some embodiments, the asphalt binder includes 10 percent by volume of the waste plastic material and 90 percent by volume of the liquid binder base.

In some embodiments, the liquid binder base and the plurality of unprocessed granules of the waste plastic material are mixed in the storage tank at a temperature of 325° F. for a duration of 20 minutes to form the asphalt binder.

In some embodiments, each of the plurality of unprocessed granules of the waste plastic material is less than or equal to ½ inch in size.

In some embodiments, the waste plastic material includes plastic material from recycling grades 3, 5, 6, and 7.

In some embodiments, the waste plastic material includes polystyrene.

In some embodiments, the liquid binder base includes up to 50 percent by volume of reclaimed asphalt pavement.

In some embodiments, the storage tank includes a high-shear mill for mixing the liquid binder base and the waste plastic material to form the asphalt binder.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a schematic view of a system for forming an asphalt binder according to an exemplary embodiment of the present technology.

FIG. 2 is a flowchart showing a method of forming an asphalt binder using the system of FIG. 1 according to an exemplary embodiment of the present technology.

FIG. 3 is a schematic view of a system for forming an asphalt binder according to an exemplary embodiment of the present technology.

FIG. 4 is a flowchart showing a method of forming an asphalt binder using the system of FIG. 3 according to an exemplary embodiment of the present technology.

### DETAILED DESCRIPTION

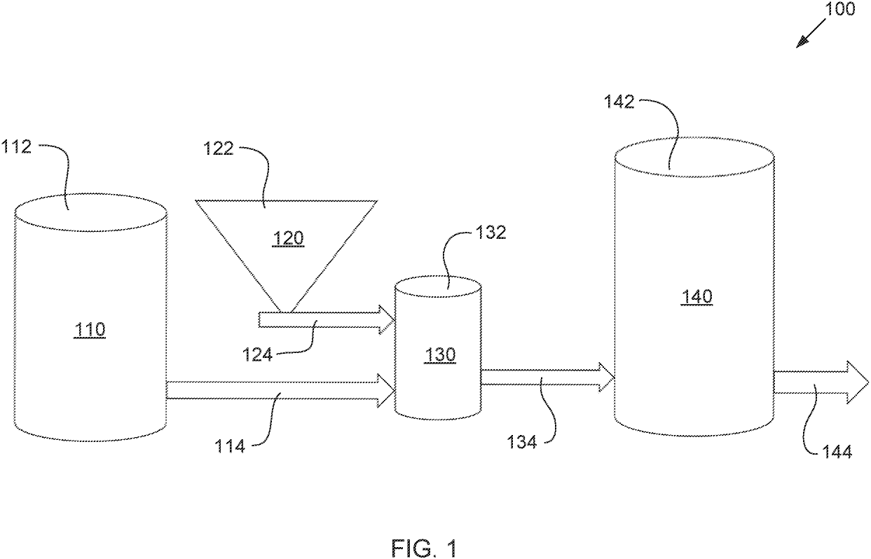

As shown in FIG. 1, an exemplary system for forming an asphalt binder is generally designated by the numeral 100. The system 100 includes a feeding tank 110 that has a binder base 112 housed therein. The binder base 112 is formed of any asphalt binder material known in the art. In some embodiments, the binder base 112 includes reclaimed asphalt pavement (“RAP”). For example, in some embodiments the binder base 112 includes up to 50 percent by volume of RAP. In some embodiments, the binder base 112 includes about 25 percent by volume of RAP. In some embodiments, the binder base 112 is in a liquid state and is heated in the feeding tank 110 to a temperature in the range of 325° F. to 350° F., and preferably to a temperature of 325° F.

In some embodiments, the system 100 includes a hopper 120 that has waste plastic 122 housed therein, as shown in FIG. 1. The waste plastic 122 is in the form of a plurality of raw, unprocessed (e.g., not chemically processed) granules that each have a size of less than or equal to one inch, and preferably less than or equal to one-half inch. The inventors of the present technology have surprisingly discovered that mixing the plurality of granules of the waste plastic 122 having the sizes disclosed herein with the binder base 112 in the critical percent by volumes and ratios disclosed herein at the critical temperatures and for the critical durations disclosed herein yields a performance graded asphalt binder 142 that has nonrecyclable waste plastic incorporated therein without negatively impacting the performance of the asphalt binder 142, as shown in the examples described herein regarding Tables 1-4. In some embodiments, the granules are formed by any means known in the art, such as mechanical resizing of the waste plastic 122. In some embodiments, the waste plastic 122 includes plastic material from recycling grades 3 (e.g., polyvinyl chloride), 5 (e.g., polypropylene), 6 (e.g., polystyrene), 7 (e.g., miscellaneous plastics not included in the other recycling grades), or combinations thereof. In some embodiments, the waste plastic 122 is polystyrene. In some embodiments, the waste plastic 122 is housed in the hopper 120 at ambient temperature.

In some embodiments, the system 100 includes a wetting tank 130, as shown in FIG. 1. The binder base 112 is pumped from the feeding tank 110 into the wetting tank 130, as indicated by arrow 114. The waste plastic 122 is distributed into the wetting tank 130, as indicated by arrow 124. In some embodiments, the waste plastic 122 is distributed into the wetting tank 130 via an auger. Once in the wetting tank 130, the waste plastic 122 and the binder base 112 are mixed to incorporate the waste plastic 122 into the binder base 112, thereby forming a blended binder 132. In some embodiments, the blended binder 132 has 5% to 40% by volume of the waste plastic 122 and 60% to 95% by volume of the binder base 112. In some embodiments, the blended binder 132 has 5% to 20% by volume of the waste plastic 122 and 80% to 95% by volume of the binder base 112. In some embodiments, the blended binder 132 has 10% by volume of the waste plastic 122 and 90% by volume of the binder base 112. The inventors of the present technology have surprisingly discovered that the percent by volumes and the ratios of the waste plastic 122 and the binder base 112 disclosed herein, when mixed at the critical temperatures for the critical durations disclosed herein, yields the performance graded asphalt binder 142 that has nonrecyclable waste plastic incorporated therein without negatively impacting the performance of the asphalt binder 142, as shown in the examples described herein regarding Tables 1-4.

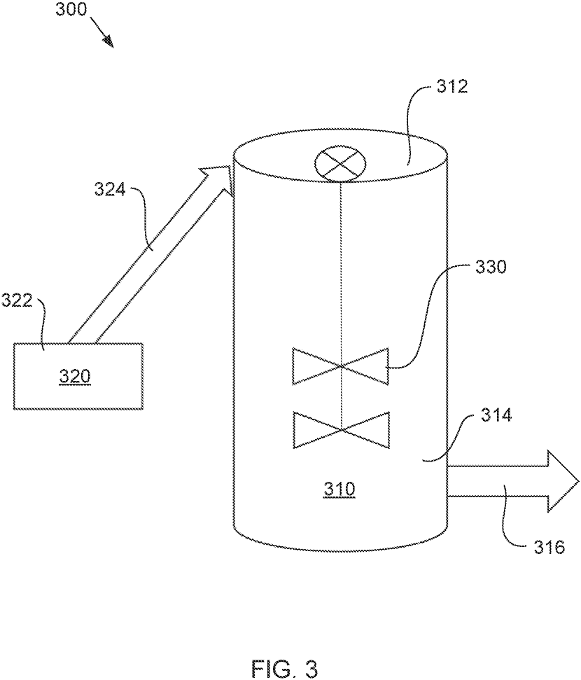

As shown in FIG. 1, the blended binder 132 is pumped from the wetting tank 130 to a storage tank 140, as indicated by arrow 134. Once in the storage tank 140, the blended binder 132 is further mixed to form an asphalt binder 142 that is ready for use. In some embodiments, the blended binder 132 is mixed in the storage tank 140 at a temperature within the range of 325° F. to 350° F., and preferably to a temperature of 325° F., for a duration within the range of 10 minutes to 30 minutes, and preferably for a duration of 20 minutes. The inventors of the present technology have surprisingly discovered that mixing the blended binder 132 (having the critical percent by volumes and the ratios of the waste plastic 122 and the binder base 112 disclosed herein) at the temperatures and for the duration disclosed herein yields the performance graded asphalt binder 142 that has nonrecyclable waste plastic incorporated therein without negatively impacting the performance of the asphalt binder 142, as shown in the examples described herein regarding Tables 1-4. After the blended binder 132 is mixed at the critical temperatures for the critical durations discussed herein to form the asphalt binder 142, the asphalt binder 142 is pumped to, for example, a hotplant for use in an asphalt mix, as indicated by arrow 144. In some embodiments, the storage tank 140 includes a high-shear mill, such as the vertical mixer 330 shown in FIG. 3, for mixing the blended binder 132 and forming the asphalt binder 142. In such embodiments where a high-shear mill is used, a particular blending time is not required to form the asphalt binder 142.

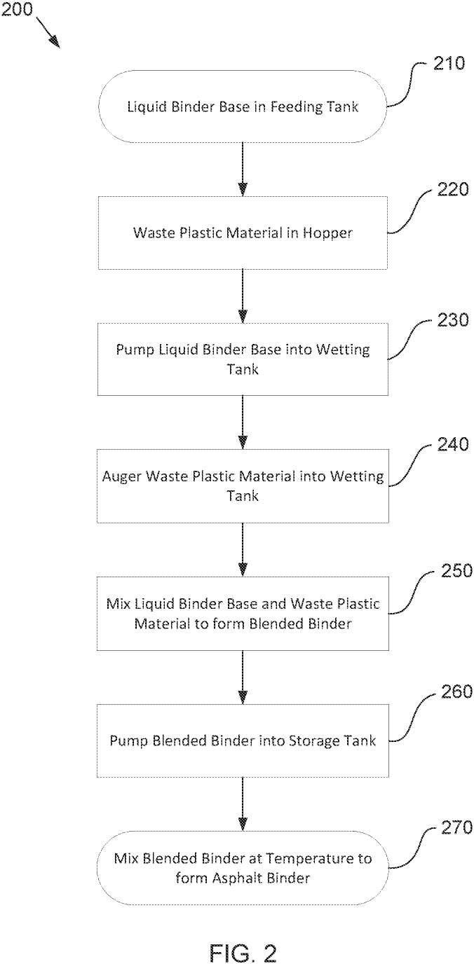

As shown in FIG. 2, an exemplary method of forming an asphalt binder via the system 100 is generally designated by the numeral 200. At step 210, the method 200 includes providing the liquid binder base 112 that is housed in the feeding tank 110. In some embodiments, the method 200 includes heating the liquid binder base 112 in the feeding tank 110 to a temperature in the range of 325° F. to 350° F., and preferably to a temperature of 325° F. At step 220, the method 200 includes providing the plurality of unprocessed granules of the waste plastic 122 that is housed in the hopper 120. At step 230, the method 200 includes pumping the liquid binder base 112 into the wetting tank 130. At step 240, the method 200 includes augering the plurality of unprocessed granules of the waste plastic 122 into the wetting tank 130. At step 250, the method 200 includes mixing the liquid binder base 112 and the plurality of unprocessed granules of the waste plastic 122 to form the blended binder 132. At step 260, the method 200 includes pumping the blended binder 132 into the storage tank 140. At step 270, the method 200 includes mixing the blended binder 132 at the critical temperatures for the critical durations discussed herein to from the asphalt binder 142. The system 100 and the method 200 shown and discussed regarding FIGS. 1-2 are useful as a continuous process yielding a high production rate of the asphalt binder 142.

As shown in FIG. 3, another exemplary system for forming an asphalt binder is generally designated by the numeral 300. The system 300 includes a storage tank 310 that has a binder base 312 housed therein. The binder base 312 is formed of any asphalt binder material known in the art. In some embodiments, the binder base 312 includes up to 50 percent by volume of RAP. In some embodiments, the binder base 312 includes about 25 percent by volume of RAP. In some embodiments, the binder base 312 is in a liquid state and is heated in the storage tank 310 to a temperature in the range of 325° F. to 350° F., and preferably to a temperature of 325° F.

In some embodiments, the system 300 includes a container (e.g., a box, a bucket, etc.) 320 that has waste plastic 322 housed therein, as shown in FIG. 3. The waste plastic 322 is in the form of a plurality of raw, unprocessed (e.g., not chemically processed) granules that each have a size of less than or equal to one inch, and preferably less than or equal to one-half inch. The inventors of the present technology have surprisingly discovered that mixing the plurality of granules of the waste plastic 322 having the sizes disclosed herein with the binder base 312 in the critical percent by volumes and ratios disclosed herein at the critical temperatures and for the critical durations disclosed herein yields a performance graded asphalt binder 314 that has nonrecyclable waste plastic incorporated therein without negatively impacting the performance of the asphalt binder 314, as shown in the examples described herein regarding Tables 1-4. In some embodiments, the granules are formed by any means known in the art, such as mechanical resizing of the waste plastic 322. In some embodiments, the waste plastic 322 includes plastic material from recycling grades 3 (e.g., polyvinyl chloride), 5 (e.g., polypropylene), 6 (e.g., polystyrene), 7 (e.g., miscellaneous plastics not included in the other recycling grades), or combinations thereof. In some embodiments, the waste plastic 322 is polystyrene. In some embodiments, the waste plastic 322 is housed in the container 320 at ambient temperature.

As shown in FIG. 3, the waste plastic 322 is distributed from the container 320 into the storage tank 310 that has the binder base 312 housed therein, as indicated by arrow 324. In some embodiments, the waste plastic 322 is distributed into the storage tank 310 via pouring, or dumping, by, for example, a bucket elevator. Once in the storage tank 310, the binder base 312 and the waste plastic 322 are mixed to form an asphalt binder 314 that is ready for use. In some embodiments, the asphalt binder 314 has 5% to 40% by volume of the waste plastic 322 and 60% to 95% by volume of the binder base 312. In some embodiments, the asphalt binder 314 has 5% to 20% by volume of the waste plastic 322 and 80% to 95% by volume of the binder base 312. In some embodiments, the asphalt binder 314 has 10% by volume of the waste plastic 322 and 90% by volume of the binder base 312. The inventors of the present technology have surprisingly discovered that the percent by volumes and the ratios of the waste plastic 322 and the binder base 312 disclosed herein, when mixed at the critical temperatures for the critical durations disclosed herein, yields the performance graded asphalt binder 314 that has nonrecyclable waste plastic incorporated therein without negatively impacting the performance of the asphalt binder 314, as shown in the examples described herein regarding Tables 1-4.

In some embodiments, the binder base 312 and the waste plastic 322 are mixed in the storage tank 310 at a temperature within the range of 325° F. to 350° F., and preferably to a temperature of 325° F., for a duration within the range of 10 minutes to 30 minutes, and preferably for a duration of 20 minutes. The inventors of the present technology have surprisingly discovered that mixing the waste plastic 322 and the binder base 312 having the critical percent by volumes and the ratios disclosed herein at the temperatures and for the duration disclosed herein yields the performance graded asphalt binder 314 that has nonrecyclable waste plastic incorporated therein without negatively impacting the performance of the asphalt binder 314, as shown in the examples described herein regarding Tables 1-4. After the binder base 312 and the waste plastic 322 are mixed at the critical temperatures for the critical durations discussed herein to form the asphalt binder 314, the asphalt binder 314 is pumped to, for example, a hotplant for use in an asphalt mix, as indicated by arrow 316. In some embodiments, the storage tank 310 includes a high-shear mill, such as a vertical mixer 330, for mixing the binder base 312 and the waste plastic 322 to form the asphalt binder 314. In such embodiments where a high-shear mill is used, a particular blending time is not required to form the asphalt binder 314.

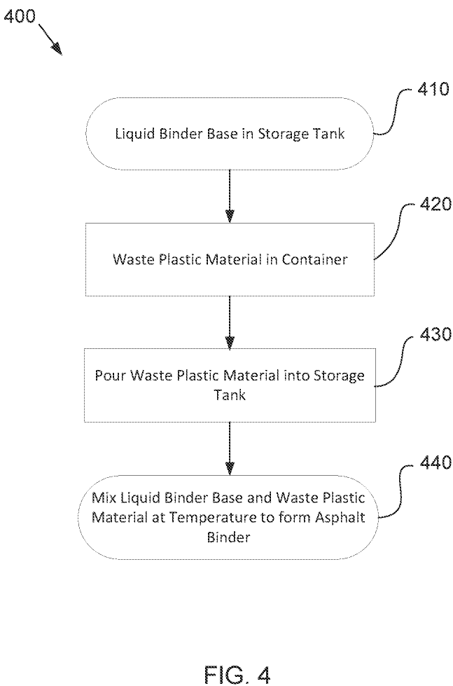

As shown in FIG. 4, another exemplary method of forming an asphalt binder via the system 300 is generally designated by the numeral 400. At step 410, the method 400 includes providing the liquid binder base 312 that is housed in the storage tank 310. In some embodiments, the method 400 includes heating the liquid binder base 312 in the storage tank 310 to a temperature in the range of 325° F. to 350° F., and preferably to a temperature of 325° F. At step 420, the method 400 includes providing the plurality of unprocessed granules of the waste plastic 322 that is housed in the container 320. At step 430, the method 400 includes pouring the plurality of unprocessed granules of the waste plastic 322 into the storage tank 310. At step 440, the method 400 includes mixing the liquid binder base 312 and the plurality of unprocessed granules of the waste plastic 322 at the critical temperatures for the critical durations discussed herein to from the asphalt binder 314. The system 300 and the method 400 shown and discussed regarding FIGS. 3-4 are useful as a batch process yielding a low production rate of the asphalt binder 314.

### Examples

In an exemplary embodiment, a low carbon mix asphalt binder was formed as described herein including 25 percent RAP and 10 percent plastic. The asphalt binder was compared to a control mix having 25 percent RAP. The results are shown in Table 1 below. Notably, the low carbon mix asphalt binder provided a significant improvement over the control mix in crack resistance with a factor of 3. Also, the addition of 10 percent plastic improved the binder grade from 58-22 to 64-22, which enlarged the useful temperature interval from 80 to 86.

TABLE 1

Comparison of asphalt binder and control mix

| | Low carbon asphalt binder (10% plastic) | Control mix |
|---|---|---|
| % RAP | 25 | 25 |
| Virgin binder used | PG58-22 | PG58-22 |
| Desired binder grade | PG64-16 | PG64-16 |
| Grading after addition of plastic | 64-22 | 58-22 |
| True grading | 64.7-30.1 (18.8) | 62.9-30.5 (18.2) |
| ΔTc | 0 | 0.8 |
| | JMF Data | |
| 1″ | 100 | 100 |
| ¾″ | 98 | 98 |
| ½″ | 83 | 89 |
| ⅜″ | 66 | 78 |
| #4 | 47 | 52 |
| #8 | 33 | 36 |
| #16 | 19 | 26 |
| #30 | 16 | 18 |
| #50 | 10 | 12 |
| #100 | 6 | 8 |
| #200 | 4.2 | 5.1 |
| AC content | 4.55 | 4.76 |
| Air voids | 3.43 | 2.64 |
| VMA | 13.7 | 13.5 |
| TSR (dry strength, psi) | 156 | 202 |
| TSR (wet strength, psi) | 144 | 176 |
| TSR% (wet/dry) | 93 | 87 |
| HWT (max deformation, nm) | 1.692 | 1.427 |
| Avg. crack index (2 hr) | 40.8 | 13.2 |

In an exemplary embodiment, a low carbon asphalt binder was formed as described herein having 5 percent plastic. The asphalt binder was successfully emulsified for surface treatment applications such as fog seal and slurry. The asphalt binder was compared to a control emulsion, the results of which are shown in Table 2 below. Notably, the low carbon asphalt binder emulsion provided significant improvement over the control emulsion in penetration, softening point, and ductility.

TABLE 2

Comparison of asphalt binder emulsion and control emulsion

| | Low carbon asphalt binder | Control |
|---|---|---|
| Emulsion | LMCQS-1h low carbon | LMCQS-1h |
| Grade | Low carbon asphalt binder with 5% plastic | Emulsion base stock |
| Sieve | 0 | 0 |
| Viscosity, SFS | 23 | 41 |
| Stability 24 hr, % | 0.8 | 1 |
| Residue, % | 61.8 | 60.8 |
| Softening point, F | 144 | 141 |
| Penetration, dmm | 37 | 51 |
| Ductility, mm | 580 | 470 |

In an exemplary embodiment, a low carbon asphalt binder was formed as described herein having 10 percent plastic. The asphalt binder was successfully incorporated with 18 percent crumb rubber with no negative impact on performance. The asphalt binder was compared to a control mix, the results of which are shown in Table 3 below. Notably, the asphalt binder met the current Asphalt Rubber Specifications.

TABLE 3

Comparison of asphalt binder and control mix

| | Control mix with 18% crumb rubber and 2% extender oil | Low carbon asphalt binder with 10% plastic, 18% crumb rubber, and 2% extender oil |
|---|---|---|
| Viscosity at 190C, Pa*s | 2500 | 2200 |
| Resilience, 77F, % | 50 | 48 |
| Ring & Ball, soft point, C | 73 | 72 |
| Cone Penetration, 77F, dmm | 28 | 28 |

Accordingly, embodiments of the present technology discussed herein form performance graded asphalt binders that have waste plastic incorporated therein without negatively impacting the performance of the resulting asphalt binder. The waste plastic is preferably of plastic grades not suitable for recycling into new plastic products (e.g., plastic from recycling grades 3, 5, 6, and 7). The waste plastic is dissolved into the binder solution to displace a portion of the liquid binder base, and the waste plastic is storage stable after blending with the binder base. In some embodiments, the asphalt binder is a low carbon binder mix. The systems and methods discussed herein may be performed at a liquid asphalt terminal or any other facility suited for blending liquid asphalt products. In preferred embodiments, no additives or compatibilizers are added to the waste plastic. In some embodiments, the waste plastic is incorporated with polyphthalamide (“PPA”), polymers, or other additives. The asphalt binder has a wide range of applications, from roofing products to pavement construction and pavement preservation such as emulsion and cutbacks, in addition to improving Environmental Product Declaration (“EPD”) values. As shown in Table 4 below, the asphalt binder provides an average of 10 percent reduction in EPD values.

TABLE 4

Environmental Product Declaration Values

| | | Without Plastic Mix | | | With Plastic Mix | | | |
|---|---|---|---|---|---|---|---|---|
| Title | Unit | Materials | Binder Impact | Percent Binder Impact | Materials | Binder Impact | Percent Binder Impact | Percent Reduction |
| Acidification | Kg SO2 eq. | 0.117 | 0.096 | 82% | 0.107 | 0.087 | 81% | 9% |
| Ecotoxicity | CTU eco. | 1.114 | 1.107 | 99% | 1.003 | 0.996 | 99% | 10% |
| Eutrophication | Kg N eq. | 0.007 | 0.007 | 100% | 0.006 | 0.006 | 100% | 14% |
| Global Warming Air | Kg CO2 eq. | 19.9 | 16.43 | 83% | 18.2 | 14.78 | 81% | 9% |
| Ozone Depletion | Kg CFC- 11 eq. | 4.17E-09 | 3.30E- 09 | 79% | 3.84E-09 | 2.97E- 09 | 77% | 8% |
| Smog | Kg O3 eq. | 2.113 | 1.858 | 88% | 1.928 | 1.672 | 87% | 9% |
| | | | | | | | Ave. Reduction | 10% |

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ± 5%, ± 10%, ± 20%, or ± 25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A method of forming an asphalt binder comprising:
providing a liquid binder base housed in a feeding tank;
providing a plurality of unprocessed granules of a waste plastic material housed in a hopper;
pumping the liquid binder base into a wetting tank;
augering the plurality of unprocessed granules of the waste plastic material into the wetting tank;
mixing the liquid binder base and the plurality of unprocessed granules of the waste plastic material to form a blended binder comprising 5 percent to 40 percent by volume of the waste plastic material and 60 percent to 95 percent by volume of the liquid binder base;
pumping the blended binder into a storage tank; and
mixing the blended binder at a temperature of 325° F. to 350° F. for a duration of 10 minutes to 30 minutes to form the asphalt binder.

2. The method of claim 1, wherein the blended binder comprises 5 percent to 20 percent by volume of the waste plastic material and 80 percent to 95 percent by volume of the liquid binder base.

3. The method of claim 1, wherein the blended binder comprises 10 percent by volume of the waste plastic material and 90 percent by volume of the liquid binder base.

4. The method of claim 1, wherein the blended binder is mixed in the storage tank at a temperature of 325° F. for a duration of 20 minutes to form the asphalt binder.

5. The method of claim 1, further comprising heating the liquid binder base within the feeding tank to a temperature of 325° F.

6. The method of claim 1, wherein each of the plurality of unprocessed granules of the waste plastic material is less than or equal to 1 inch in size.

7. The method of claim 1, wherein each of the plurality of unprocessed granules of the waste plastic material is less than or equal to ½ inch in size.

8. The method of claim 1, wherein the waste plastic material comprises plastic material from recycling grades 3, 5, 6, and 7.

9. The method of claim 1, wherein the waste plastic material comprises polystyrene.

10. The method of claim 1, wherein the liquid binder base comprises up to 50 percent by volume of reclaimed asphalt pavement.

11. The method of claim 1, wherein the storage tank comprises a high-shear mill for mixing the blended binder.

12. A method of forming an asphalt binder, comprising:
providing a liquid binder base housed in a storage tank;
providing a plurality of unprocessed granules of a waste plastic material housed in a container, each of the plurality of unprocessed granules of the waste plastic material is less than or equal to 1 inch in size;
pouring the plurality of unprocessed granules of the waste plastic material into the storage tank; and
mixing the liquid binder base and the plurality of unprocessed granules of the waste plastic material at a temperature of 325° F. to 350° F. for a duration of 10 minutes to 30 minutes to form the asphalt binder comprising 5 percent to 40 percent by volume of the waste plastic material and 60 percent to 95 percent by volume of the liquid binder base.

13. The method of claim 12, wherein the asphalt binder comprises 5 percent to 20 percent by volume of the waste plastic material and 80 percent to 95 percent by volume of the liquid binder base.

14. The method of claim 12, wherein the asphalt binder comprises 10 percent by volume of the waste plastic material and 90 percent by volume of the liquid binder base.

15. The method of claim 12, wherein the liquid binder base and the plurality of unprocessed granules of the waste plastic material are mixed in the storage tank at a temperature of 325° F. for a duration of 20 minutes to form the asphalt binder.

16. The method of claim 12, wherein each of the plurality of unprocessed granules of the waste plastic material is less than or equal to ½ inch in size.

17. The method of claim 12, wherein the waste plastic material comprises plastic material from recycling grades 3, 5, 6, and 7.

18. The method of claim 12, wherein the waste plastic material comprises polystyrene.

19. The method of claim 12, wherein the liquid binder base comprises up to 50 percent by volume of reclaimed asphalt pavement.

20. The method of claim 12, wherein the storage tank comprises a high-shear mill for mixing the liquid binder base and the waste plastic material to form the asphalt binder.
